(19) United States
(12) Patent Application Publication
(10) Pub. No.: US 2009/0140198 A1
(43) Pub. Date: Jun. 4, 2009

(54) Method of preparing metal oxide suspension

(75) Inventors: Yoon-Gyu Lee, Gyeonggi-do (KR); Jin-Ho Lee, Gyeonggi-do (KR); Myung-Geun Song, Gyeonggi-do (KR); Sin-Ae Song, Seoul (KR); Ja-Hoo Koo, Gyeonggi-do (KR)

Correspondence Address: MCDERMOTT WILL & EMERY LLP, 600 13TH STREET, N.W., WASHINGTON, DC, 20005-3096, US

(73) Assignees: SAMSUNG CORNING CO., LTD., Suwon-si, Gyeonggi-do (KR); SAMSUNG CORNING PRECISION GLASS CO., LTD., Gumi (KR)

(21) Appl. No.: 11/918,856

(22) PCT Filed: Apr. 18, 2006
(86) PCT No.: PCT/KR2006/001431

§ 371 Date: Oct. 19, 2007

(30) Foreign Application Priority Data
Apr. 21, 2005 (KR) 10-2005-0033248

(51) Int. Cl. C09K 13/00

(52) U.S. Cl. 252/79.1

(57) ABSTRACT

Disclosed herein is a method of preparing a metal oxide suspension, which is advantageous due to the prevention of hydration and agglomeration of the metal oxide and a simple preparation process. The method of preparing a metal oxide suspension according to this invention includes preparing metal oxide, mixing the metal oxide with a solvent and a surface treating agent to obtain a mixture, and wet milling the mixture such that the metal oxide of the mixture has a nanoscale particle size and the metal oxide is uniformly dispersed in the mixture.

### TECHNICAL FIELD

The present invention relates to a method of preparing a metal oxide suspension and, more particularly, to a method of preparing a metal oxide suspension, in which hydration and agglomeration of nanoscale metal oxide can be prevented and a wet milling process can be adopted to simplify the preparation process for the metal oxide suspension.

### BACKGROUND ART

Generally, a metal oxide suspension has been widely applied to slurry for use in paint, cosmetics, medical materials, and in the process of planarizing semiconductor components.

In particular, the metal oxide suspension is commonly used in a chemical mechanical polishing (CMP) process, a technique for planarizing semiconductor components. The CMP process, as a polishing technique, typically combines chemical and mechanical polishing to perform the polishing and washing process in a single-step process, which results in the planarizing flatness of 100˜1000 times better than other planarizing techniques. Thus, the CMP process has been drawing much attention as one of the latest planarizing techniques in the art.

The CMP process requires the use of a slurry for polishing. As such, as the slurry, a metal oxide suspension comprising nanoscale metal oxide may be used.

According to the conventional methods of preparing a metal oxide suspension, a metal oxide is nanoscaled through a dry milling process, a fuming process, or a colloidal process, and is then dispersed with a dispersing agent in a solvent.

However, the conventional methods of preparing a metal oxide suspension has a drawback in that the nanoscaling process and the process of dispersion in a solvent must be performed separately, which complicates the preparation process and consequently results in a low process efficiency and a high preparation cost. Further, when unstable nanoscale metal oxide is dispersed in the solvent such as distilled water, it may be undesirably hydrated, leading to agglomerated powder. In some cases, the phase of the metal oxide may also change.

### DISCLOSURE OF INVENTION

### Technical Problem

In view of the foregoing, it is an object of the present invention is to provide a method of preparing a metal oxide suspension, in which the preparation process is simplified by implementing a wet milling process, thus increasing the preparation efficiency and decreasing the preparation cost of the metal oxide suspension.

Another object of the present invention is to provide a method of preparing a metal oxide suspension, in which agglomeration of metal oxide cause by hydration can be prevented.

### Technical Solution

In order to accomplish the above objects, the present invention provides a method of preparing a metal oxide suspension. The method includes preparing a metal oxide, mixing the metal oxide with a solvent and a surface treating agent to obtain a mixture, and wet milling the mixture such that the metal oxide of the mixture has a nanoscale particle size and the metal oxide is uniformly dispersed in the mixture without agglomeration of the metal oxide.

### DESCRIPTION OF DRAWINGS

The above and other objects, features and advantages of the present invention will be more clearly understood from the following detailed description taken in conjunction with the accompanying drawings, in which:

FIG. 1 is a flowchart showing a process of preparing a metal oxide suspension, according to an embodiment of the present invention;

FIG. 2 is a flowchart showing a process of preparing a metal oxide suspension, according to another embodiment of the present invention;

FIG. 3 is a graph showing the result of X-ray diffraction of the metal oxide suspension obtained in Example 1; and

FIG. 4 is a graph showing the result of X-ray diffraction of the metal oxide suspension obtained in Comparative Example 1.

### MODE FOR INVENTION

Reference should now be made to the drawings, in which the same reference numerals are used throughout the different drawings to designate the same or similar components.

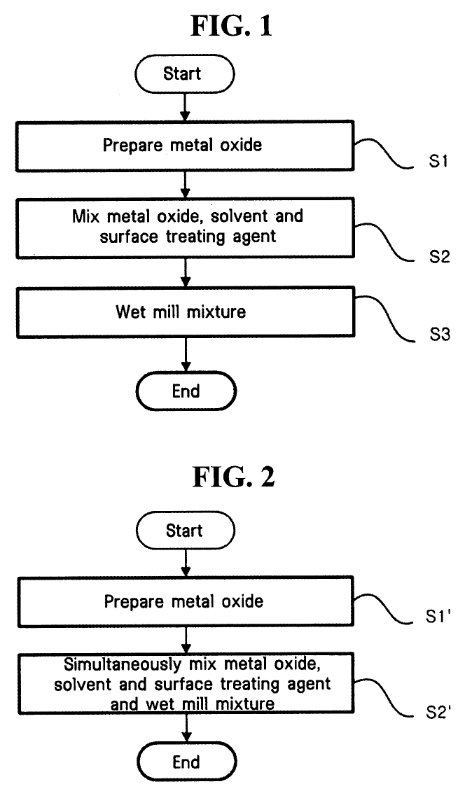

FIG. 1 is a flowchart showing a process of preparing a metal oxide suspension, according to an embodiment of the present invention.

As shown in FIG. 1, metal oxide is first prepared (S1).

Such metal oxide results from heat treatment of metal hydroxide. In the method according to the first embodiment of the present invention, the metal oxide comprises at least one selected from the group consisting of alumina (Al2O3), magnesia (MgO2), zirconia (ZrO2), ceria (CeO2), titania (TiO2), tungsten oxide (WO3), and mixtures thereof, but is not limited thereto.

In such a case, alumina is exemplified by transition alumina, such as γ-, θ-, κ-, δ-, or τ-alumina.

As such, the metal oxide may be in the form of powder. To this end, metal hydroxide is powdered and then appropriately heat treated to be converted into powdery metal oxide. Alternatively, metal hydroxide may be converted into metal oxide through heat treatment and then powdered. The powdery metal oxide may have a particle size of 1˜8 μm, but is not limited thereto.

Then, the metal oxide thus obtained is mixed with a solvent and a surface treating agent (S2).

Examples of the solvent include, but are not limited to, distilled water and deionized water.

The surface treating agent, which is adsorbed on the surface of the metal oxide, functions to prevent the surface of the metal oxide from hydration by the solvent and to effectively disperse the metal oxide in the solvent.

When the particle size of the metal oxide is on the nanoscale, the specific area of the metal oxide is increased, thus increasing the surface energy of the metal oxide. As such, in the case where the solvent is distilled water or deionized water, the surface of unstable metal oxide, having high surface energy, reacts with distilled water or deionized water and is thus undesirably converted into metal hydroxide. Consequently, the metal oxide loses its inherent properties. In certain cases, the dispersion stability of the suspension is deteriorated.

Therefore, the surface treating agent, having a reactive group able to be adsorbed on the surface of the metal oxide, is contained in the mixture, such that it is adsorbed on the surface of the metal oxide to prevent contact between the surface of the metal oxide and solvent particles, therefore inhibiting hydration. Specifically, in a powdering process, such as wet milling, since metal oxide breaks due to collision with beads, it has a newly formed surface. In this case, the surface treating agent, having an adsorption ability higher than that of solvent particles such as water molecules, is adsorbed on the newly formed surface of the metal oxide, thus forming a protective layer. Thereby, surface hydration between the water molecules and the metal oxide can be effectively inhibited.

Further, in the case where transition alumina, having an unstable phase, is used as the metal oxide, when its nanoscale particles are dispersed in the solvent such as ultrapure water, hydration proceeds through association with water molecules at the surface of the particles, and the phase or morphology of the particles may change. In particular, in the case of γ-alumina, it may be sequentially converted into phases of amorphous gel, boehmite, and then bayerite in an aqueous solution, resulting in aluminum hydroxide, which is evidently different from the initial γ-alumina phase. As such, the surface treating agent contained in the mixture functions to block the change of phase of the metal oxide. That is, when the surface treating agent is adsorbed on the surface of γ-alumina to form the protective layer as mentioned above, the association between γ-alumina and the water molecules is blocked, thus preventing in advance the change of phase of the metal oxide.

In addition, the surface treating agent adsorbed on the surface of the particles may act to increase the surface charge of the metal oxide. In particular, in the case of a polymeric surface treating agent, it may exhibit a steric hindrance effect that obstructs physical contact of the particles by the polymer chain, thus sufficiently conferring dispersion stability to the suspension.

The surface treating agent is not particularly limited so long as it has a reactive group capable of being adsorbed on the surface of the metal oxide. For example, the surface treating agent may have an ionic functional group, such as a carboxyl group, a sulfuric acid group, a phosphoric acid group, a nitric acid group, etc., or a non-ionic functional group, such as ethylene oxide.

Specific examples of the surface treating agent include organic acids, such as citric acid, phthalic acid, and/or maleic acid. Preferably, an organic acid containing at least one carboxyl group may be used.

In addition, as the surface treating agent, an oligomeric surfactant may be used. Specifically, a cationic surfactant or a non-ionic surfactant may be used, or an oligomeric anionic surfactant, having at least one functional group selected from the group consisting of a sulfonic acid, a sulfonate, a phosphonic acid, a phosphonate, and a phosphate, may be used.

In addition, as the surface treating agent, a polymer having the above functional groups may be used. Specifically, a polymer or a salt thereof, containing at least one functional group selected from the group consisting of a carboxylic acid, a carboxylate, a sulfonate, a phosphonic acid, a phosphonate, a phosphate, and an ethylene oxide, may be used. For example, a polyelectrolyte and a salt thereof, such as poly(carboxylic acid), poly(methacrylic acid), etc., or a non-ionic polymer, such as poly(ethylene glycol), poly(vinyl pyrrolidone), etc., may be used.

In addition, as the surface treating agent, a copolymer containing two or more hydrophilic ionic groups may be used. Particularly useful is a copolymer, which is obtained by polycondensing at least one monomer containing a carboxylic acid, a carboxylate, a sulfonate, a phosphonic acid, a phosphonate, or a phosphate, serving as one comonomer unit, and at least one monomer containing at least one amide selected from the group consisting of formamide, dimethylformamide, acetamide, benzamide and acrylamide, serving as another comonomer unit.

The above materials listed as the examples of the surface treating agent may be used alone or in combinations of two or more.

Subsequently, the mixture thus obtained is subjected to wet milling (S3).

The wet milling process includes a physical step causing defects on the surface of the metal oxide and a chemical step for reacting the surface of the metal oxide, having defects, with the surface treating agent, and thus can realize a surface treatment effect that is superior to a dry milling process. In the dry milling process, since balls used as a milling medium cannot be reduced to a predetermined size or less due to their mechanical and physical properties, the particle size of the metal oxide obtained through such milling cannot but have a limit. However, in the wet milling process, since very small balls, called beads, may be used as a milling medium due to the presence of the solvent such as a dispersing solvent, the particle size of the metal oxide can be achieved on the nanoscale.

In order to perform the wet milling process, the mixture is supplied into a wet milling machine at a predetermined flow rate, such that the metal oxide of the mixture is milled by the beads in the wet milling machine.

The type and size of beads used for wet milling may vary depending on the type and desired particle size of the metal oxide. For example, the beads may have a size of 0.01˜2.0 mm, and are exemplified by zirconia, alumina, silica-alumina, silica, magnesia, titania, yttria, and ferrite. In particular, the use of zirconia, alumina, or silica is preferable.

The process of milling the mixture through wet milling may be repeatedly performed until the particle size of the metal oxide of the mixture reaches a desired size, for example, 10˜300 nm. While the metal oxide of the mixture is milled to be smaller through such a wet milling process, the surface treating agent is adsorbed on the surface of the metal oxide. In this way, the metal oxide of the mixture is milled, and at the same time, the surface treating agent is effectively adsorbed on the surface of the milled metal oxide, thus preventing contact between the surface of the metal oxide and distilled water or deionized water, preventing the hydration of the metal oxide. As a result, the phase variation or transition of the metal oxide, which is induced by hydration, does not occur. As well, no agglomeration occurs, and therefore dispersion stability is ensured.

Although the wet milling process is performed one time, it may be optionally performed two or more times. That is, the procedure, the suspension resulting from the milling process may be subjected the wet milling process for at least one more time, thereby preparing a nano-suspension having a desired size.

In the preparation of the metal oxide suspension, an additive may be further added when mixing the metal oxide, the solvent, and the surface treating agent or after the wet milling process, in order to improve the properties appropriate for the end use of the metal oxide suspension.

For example, in the case of a slurry for CMP of metal, one or more additives selected from among an oxidant, a complexing agent, an antioxidant, and a pH controlling agent may be used, but the present invention is not limited thereto.

When using the metal oxide suspension as a slurry for CMP, the oxidant functions to oxidize a metal layer to be polished into corresponding oxide, hydroxide or ions through the reaction with the metal layer. For example, the oxidant may be used to oxidize tungsten into tungsten oxide and copper into copper oxide. Although the oxidant usable for the metal oxide suspension is not particularly limited, hydrogen peroxide (H2O2) is useful. In addition, for the preparation of the metal oxide suspension, the oxidant is used in an amount of about 0.2˜30 wt %, and preferably about 1.0˜15 wt %.

When using the metal oxide suspension as a slurry for CMP, the complexing agent functions to chemically eliminate the oxide layer formed by the oxidant or to limit the thickness of the oxidized layer through the formation of a complex with the oxidized metal. For instance, in the case of a copper film, the oxidant acts to form copper oxide, and the complexing agent acts to decompose the formed copper oxide into a copper ion so as to form a complex with the produced copper ion. In addition, since the complexing agent is coupled with the oxide present on the surface of copper to stabilize the surface of copper, it may perform the function of controlling the formation of an oxide film. Although the complexing agent used for the metal oxide suspension is not particularly limited, at least one selected from among ammonium oxalate, tartaric acid, nitrilo triacetic acid, amino diacetic acid, amine carboxylate, amino acetic acid, and ammonium citrate may be used. The complexing agent for the preparation of the metal oxide suspension is used in an amount of about 0.2˜5.0 wt %, and preferably 0.3˜3.0 wt %.

When using the metal oxide suspension as a slurry for CMP, the antioxidant functions to accelerate the formation of a passivating layer or a dissolution prevention layer on the surface of the material to be polished, thereby increasing the flatness of the polished material. As the antioxidant usable for the metal oxide suspension, benzotriazole (BTA) and/or triazole derivatives are exemplary. The amount of antioxidant used for the metal oxide suspension is in the range of about 0.001˜1.0 wt %, and preferably 0.001˜0.3 wt %, and may change depending on the amount of complexing agent.

When using the metal oxide suspension as a slurry for CMP, the pH controlling agent functions to control the pH of the metal oxide suspension to about 2.0˜12.0, and preferably 4.0˜9.0, in order to easily perform the CMP process. As the pH controlling agent, known acids, bases, or amines may be used. For example, ammonium hydroxide and amine, or nitric acid, sulfuric acid, phosphoric acid, and an organic acid may be used.

Turning now to FIG. 2, a flowchart showing a process of preparing a metal oxide suspension, according to a second embodiment of the present invention, is shown.

As shown in FIG. 2, the process according to another embodiment is performed in the same manner as in the process according to the first embodiment, with the exception that a metal oxide is prepared (S1′), and then the metal oxide, the solvent and the surface treating agent are mixed, and at the same time, the mixture is subjected to wet milling (S2′).

A better understanding of the present invention may be obtained through the following example and comparative example, which are set forth to illustrate, but are not to be construed as the limit of the present invention.

### EXAMPLE 1

Gibbsite (Al(OH)3, H-42M, Show-Denko K. K, Japan) was heat treated at 500° C. for 2 hours and thus converted into γ-alumina (Al2O3). γ-alumina (5 wt %) and citric acid (0.35 wt %, Aldrich) were uniformly mixed with distilled water and then milled using a wet milling machine (UAM-015, Kotobuki, Japan). The chamber of the wet milling machine had a volume of 150 ml, and zirconia (ZrO2) beads having a size of 0.1 mm, serving as a milling medium, were loaded into the chamber in an amount of 80 vol % of the chamber. Upon milling, the wet milling machine was rotated at a rate of 3000 rpm, and the mixture was supplied at a rate of 200 cc/min.

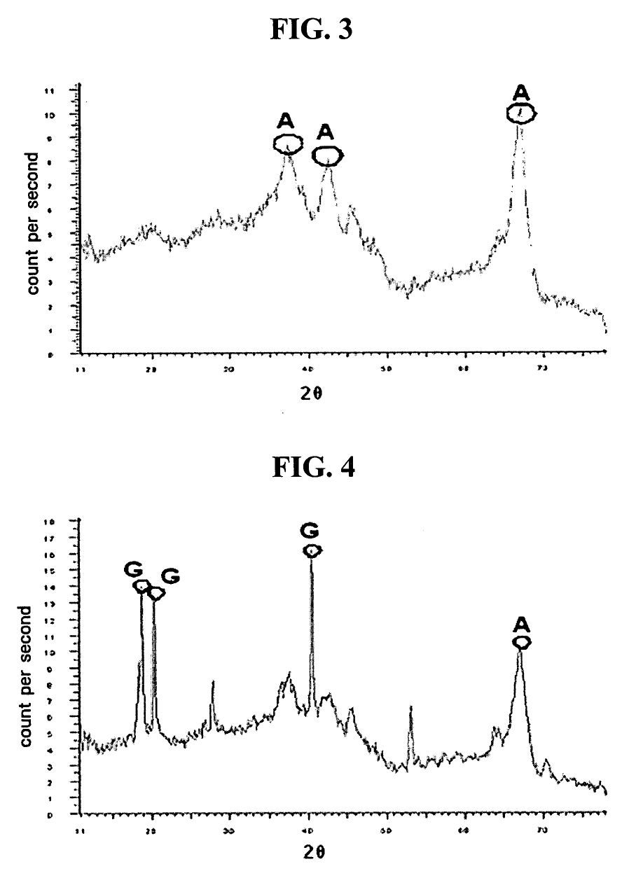

In order to determine the extent of hydration of the metal oxide suspension obtained through the milling process, the crystal phase thereof was analyzed through X-ray diffraction (D-8 Discover, Bruker, Germany). The results are given in FIG. 3.

Further, in order to confirm whether the average particle size of γ-alumina of the metal oxide suspension obtained through the milling process reached a desired size, a sample before a milling process and samples subjected to the milling process for various milling times were taken to analyze the particle size thereof using dynamic light scattering (Microtrac UPA 150). The results are given in Table 1 below.

### COMPARATIVE EXAMPLE 1

A metal oxide suspension was prepared in the same manner as in Example 1, with the exception that citric acid was not used.

The results of X-ray diffraction analysis of the crystal phase of the metal oxide suspension obtained in Comparative Example 1 and the results of analysis of particle size thereof are given in FIG. 4 and Table 1 below, respectively.

TABLE 1

| | Average Particle | Average Particle | Average Particle | Average Particle | Average Particle |
|---|---|---|---|---|---|
| | Size Before Milling | Size after Milling | Size after Milling | Size after Milling | Size after Milling |
| | (nm) | for 3 min (nm) | for 11 min (nm) | for 45 min (nm) | for 75 min (nm) |
| Ex. 1 | 1343 | 221 | 150 | 50 | 19 |
| C. Ex. 1 | 1372 | 3172 | — | — | — |

In FIGS. 3 and 4, showing the results of X-ray diffraction analysis of the crystal phase, the x-axis indicates the angle (2θ) of the detector of the X-ray diffraction device, and the y-axis indicates the count per second measured at intervals of 1° between a minimum value and a maximum value of the angle (2θ) of the detector. Referring to the above drawings, in the case of the metal oxide suspension of Example 1, an inherent peak (A) of γ-alumina was observed (FIG. 3). In the case of the metal oxide suspension of Comparative Example 1, an inherent peak (A) of γ-alumina and an inherent peak (G) of gibbsite were observed (FIG. 4). Thus, γ-alumina of the metal oxide suspension of Example 1 was confirmed to maintain its original γ-alumina phase without hydration, even after the milling process.

Referring to Table 1, it could be confirmed that γ-alumina of the metal oxide suspension of Example 1 was not agglomerated while decreasing the average particle size thereof to a desired size in proportion to an increase in the milling time, whereas γ-alumina of the metal oxide suspension of Comparative Example 1 was agglomerated and thus had a particle size much larger than the initial average particle size of the metal oxide.

### INDUSTRIAL APPLICABILITY

As described above, the present invention provides a method of preparing a metal oxide suspension. According to the method of the present invention, a metal oxide suspension can be prepared to have excellent hydration prevention effect and excellent dispersion effect through a simplified preparation process by simultaneously performing a milling process, a hydration prevention process, and a dispersion process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of preparing a metal oxide suspension, the method comprising:
preparing a metal oxide;
mixing the metal oxide with a solvent and a surface treating agent to obtain a mixture; and
wet milling the mixture such that the metal oxide of the mixture has a nanoscale particle size and the metal oxide is uniformly dispersed in the mixture.

2. The method of claim 1, wherein the mixing and wet milling are performed sequentially or simultaneously.

3. The method of claim 1, wherein the phase variation of the metal oxide having a nanoscale particle size, which is induced by hydration, does not occur during the wet milling.

4. The method of claim 1, wherein the surface treating agent comprises an organic acid having at least one carboxyl group.

5. The method of claim 1, wherein the surface treating agent comprises an oligomeric anionic surfactant having at least one functional group selected from the group consisting of a sulfonic acid, a sulfonate, a phosphonic acid, a phosphonate, and a phosphate.

6. The method of claim 1, wherein the surface treating agent comprises a cationic surfactant or a non-ionic surfactant.

7. The method of claim 1, wherein the surface treating agent comprises a polymer or a salt thereof having at least one functional group selected from the group consisting of a carboxylic acid, a carboxylate, a sulfonate, a phosphonic acid, a phosphonate, a phosphate, and an ethylene oxide.

8. The method of claim 1, wherein the surface treating agent comprises a copolymer obtained by polycondensing at least one monomer having a carboxylic acid, a carboxylate, a sulfonate a phosphonic acid, a phosphonate, or a phosphate, and at least one monomer having at least one amide selected from the group consisting of formamide, dimethylformamide, acetamide, benzamide, and acrylamide.

9. The method of claim 1, wherein the metal oxide comprises at least one selected from the group consisting of alumina, magnesia, zirconia, seria, titania, zinc oxide, tungsten oxide, and mixtures thereof.

10. The method of claim 1, wherein the metal oxide is γ-, θ-, κ-, δ-, or τ-alumina.

11. The method of claim 1, wherein the metal oxide milled by the wet milling has a particle size of 10˜300 nm.

12. The method of claim 1, wherein the mixing includes adding an oxidant, a complexing agent, an antioxidant, and/or a pH controlling agent to the mixture.

13. The method of claim 1, further comprising adding an oxidant, a complexing agent, an antioxidant, and/or a pH controlling agent after the wet milling.

14. The method of claim 12 or 13, wherein the metal oxide suspension is used for chemical mechanical polishing of metal wires.

15. The method of claim 1, wherein the wet milling is performed using beads having a size of 0.01˜2.0 mm.
